(19) United States
(12) Patent Application Publication
(10) Pub. No.: US 2014/0368501 A1
(43) Pub. Date: Dec. 18, 2014

(54) METHOD FOR GENERATING A CARTOGRAPHY OF A GEOGRAPHIC AREA

(71) Applicants: Bernard Breton, Gatineau (CA); Brent Denison, Ottawa (CA)

(72) Inventors: Bernard Breton, Gatineau (CA); Brent Denison, Ottawa (CA)

(73) Assignee: INFOVISTA SA, Les Ulis (FR)

(21) Appl. No.: 14/364,956

(22) PCT Filed: Dec. 12, 2012
(86) PCT No.: PCT/FR2012/052885

§ 371 Date: Jun. 12, 2014

(30) Foreign Application Priority Data
Dec. 12, 2011 (FR) 1161467

(51) Int. Cl. G06T 17/05

(52) U.S. Cl. CPC G06T 17/05; G06T 2207/10032
USPC 345/420

(57) ABSTRACT

A method is provided for generating a cartography of a geographic area, including a step of obtaining a satellite image providing a morphology of obstacles in certain geographical positions of the area, a step of obtaining first data for the altitude of peaks of the obstacles relative to sea level, a step of obtaining second data for the altitude of the ground for the geographical positions relative to sea level, a step of calculating the height of the obstacles via the difference between the first and second data, and a step of generating the cartography by combining, in each geographical position, morphology of the obstacle with the height of the obstacle.

### BACKGROUND OF THE INVENTION

The present invention pertains to the field of telecommunications networks. It relates more particularly to a method for generating the cartography of a geographic area, this cartography being usable for modelling the propagation of electromagnetic waves in a real environment in a very extensive geographic area, for example at the scale of a country.

The following are known in particular in the current state of the art:
cartographies obtained from three-dimensional models of the obstacles. These methods are very accurate. However, they are very expensive and inconceivable on a large scale, Moreover, they are unsuitable for environments outside of urban built-up areas;
cartographies obtained from statistical models of the height of the obstacles. These methods have the advantage of being simple to implement, but are not sufficiently accurate.

The invention relates to a method for generating a cartography that does not have the drawbacks of those of the state of the art,

### PURPOSE AND SUMMARY OF THE INVENTION

More particularly, the invention relates to a method for generating a cartography of a geographic area, this method comprising:
a step of obtaining a multispectral satellite image supplying morphologies of obstacles at certain geographic positions in the area;
a step of obtaining first data on altitude of the tops of these obstacles relative to sea level;
a step of obtaining second data on altitude of the ground at these geographic positions relative to sea level;
a step of calculating the height of these obstacles by difference between the first and second data; and
a step of generating the cartography by associating, at each of the geographic positions, the morphology of the obstacle with the height of the obstacle.

Correlatively, the invention relates to a computer able to generate a cartography of a geographic area, this computer comprising:
means for obtaining a multispectral satellite image supplying morphologies of obstacles at certain geographic positions in the area;
means for obtaining first data on altitude of the tops of these obstacles relative to sea level;
means for obtaining second data on altitude of the ground at these geographic positions relative to sea level;
means for calculating the height of these obstacles by difference between the first and second data; and
means for generating the cartography by associating, at each of the geographic positions, the morphology of the obstacle with the height of the obstacle.

The invention thus proposes generating a cartography using information on morphology obtained by analysis of a multispectral satellite image, combined with data on the height of the obstacles, obtained for example by radar or laser systems on board aircraft.

The method of the invention makes it possible to obtain a highly accurate cartography with an extremely simplified calculation effort relative to those based on three-dimensional modelling of the buildings,

It can also be used for cartography of a very extensive geographic area.

In a particular embodiment, the generating method according to the invention comprises a step of correcting the morphology of an obstacle based on the height of the obstacle.

In a particular embodiment, the method for generating a cartography according to the invention comprises:
a step of obtaining third vectorial data representative of the geographic position of certain obstacles; and
a step of correcting the cartography by correcting at least the morphologies and/or the first data and/or the second data based on these third data at the position in question.

In a particular embodiment of the method for generating a cartography according to the invention, correction consists of assigning, to an obstacle the morphology of which is incompatible with its height, a dominant morphology compatible with its height among the obstacles surrounding this obstacle.

According to a second aspect, the invention relates to a method for simulating the propagation of an electromagnetic wave in a geographic area, This method comprises:
a step of generating a cartography of said geographic area according to a generating method as mentioned above; and
a step of simulating the propagation of the wave using this cartography and data on altitude of the ground relative to sea level at different geographic points in the area.

The invention also relates to the use of a cartography of a geographic area obtained according to a generating method as mentioned above for modelling the traffic in a telecommunications network,

In a particular embodiment, the various steps of the generating method are determined by computer program instructions.

Consequently, the invention also relates to a computer program on a data medium, this program being capable of being implemented by a computer, this program comprising instructions suitable for implementing the steps of the generating method as mentioned above.

This program can use any programming language, and can be in the form of source code, object code, or intermediate code between source code and object code, such as in a partially compiled form, or in any other desirable form.

The invention also relates to a computer-readable data medium, comprising computer program instructions as mentioned above.

The data medium can be any entity or device capable of storing the program. For example, the medium can comprise a storage means, such as a ROM, for example a CD ROM or a microelectronic circuit ROM, or also a magnetic recording means, for example a diskette (floppy disc) or a hard disk.

Moreover, the data medium can be a transmissible medium such as an electrical or optical signal, which can be conveyed via an electric or optical cable, by radio or by other means. The program according to the invention can in particular be downloaded from a network of the Internet type.

Alternatively, the data medium can be an integrated circuit in which the program is incorporated, the circuit being suitable for execution or for use in the execution of the method in question.

### BRIEF DESCRIPTION OF THE DRAWINGS

Other features and advantages of the invention will become clear from the description given below, referring to the attached drawings, which illustrate an embodiment example thereof that is not !imitative in any way. In the figures:

FIG. 1A shows a satellite image of a geographic area;

FIGS. 1B and 1C give examples of data used in the invention for the area in FIG. 1A;

FIG. 2 shows, in the form of a flowchart, the main steps of a method for generating a cartography according to a particular embodiment of the invention;

FIG. 3 shows diagrammatically a data structure that defines the height classes that can be assigned to a given morphology; and

FIG. 4 shows a computer according to a particular embodiment of the invention.

### DETAILED DESCRIPTION OF THE INVENTION

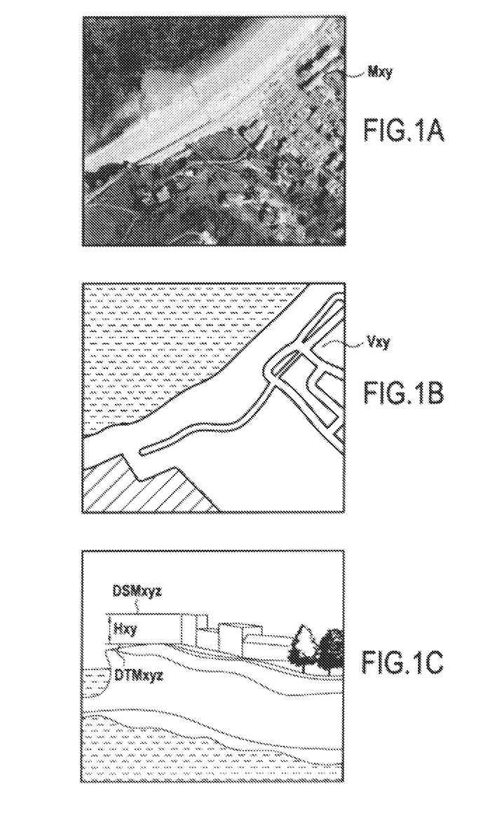

FIG. 1A shows a multispectral satellite image of a geographic area. Such an image makes it possible in particular to differentiate between a body of water and flat terrain; it also makes it possible to recognize a homogeneous forest.

FIG. 1B shows vectorial data Vxy of certain obstacles in FIG. 1A at the positions Pxy.

FIG. 1C shows, for a building in FIGS. 1A and 1B:
first data DSMxyz on altitude of the obstacles at the positions Pxy, relative to sea level;
second data DTMxyz on altitude of the ground at the positions Pxy, relative to sea level,

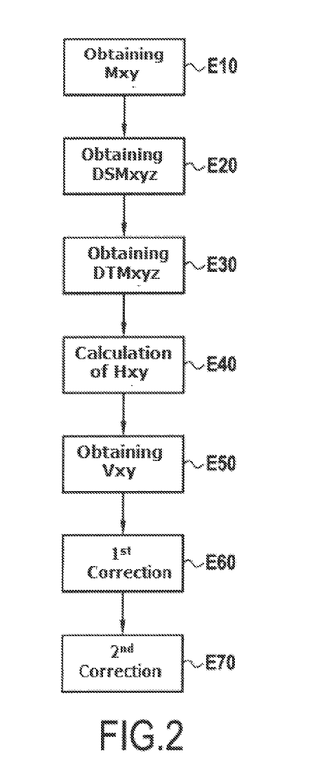

FIG. 2 shows, in the form of a flowchart, the main steps of a method for generating a cartography according to a particular embodiment of the invention.

In the course of a step E10, the multispectral satellite image in FIG. 1A is obtained and morphologies are assigned to certain obstacles in this image. For example, the morphologies correspond to grass, forests, roads, urban environments, city centres, commercial centres, buildings and the sea.

A “free” morphology is also defined for representing geographic areas free from any morphology on the ground. By way of example, the region peripheral to the city of Las Vegas, comprising neither forest nor vegetation, would predominantly be classified as “free”. This morphology is also found in cities when there are open spaces that are not transport corridors, for example parking areas.

During a step E20, the obstacles with the aforementioned morphologies situated at the positions Pxyz are assigned data DSMxyz obtained by radar representative of the height of the tops of these obstacles relative to sea level.

During a step E30, the same obstacles are assigned data DTMxyz also obtained by radar, representative of the height of the ground at this position Pxyz relative to sea level.

The method of measuring the elevation can be carried out by radar or by laser systems. These measurements can in particular be carried out from aircraft, as radar systems on board satellites do not offer sufficient resolution,

By way of example, it is possible to use radar or laser systems accurate to within 2 metres (or better) in the Z axis (vertical) and accurate to within 5 metres in the horizontal plane (X and Y axis). In a preferred embodiment, capture of the elevation is used that is carried out by the “IFSAR” (“Interferometric synthetic aperture radar”) technique of the company Intermap; the radar systems are on board aircraft. The resolution (distance between the pixels) of the information is typically 10 m or better.

During a step E40, the height Hxy of the obstacles is calculated by the difference between DSMxyz and DTMxyz.

At the end of this step, the invention makes it possible to make a first cartography, by associating a morphology Mxy and a height class with each position Pxyz. For example: forest of height [15-20 m].

The invention thus proposes correlating the morphology extracted from the multispectral satellite image and the difference between the data DSM and the data DTM.

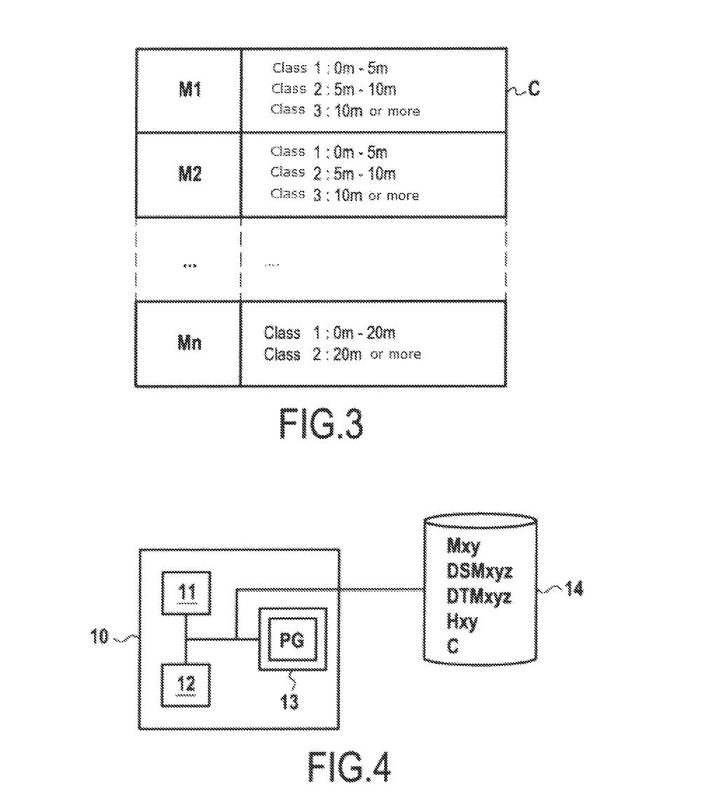

In order to carry out this first cartography, for example Table C in FIG. 3 is used, which gives the possible height classes for each morphology MI.

During a step E50, the vectorial data Vxy of certain obstacles, at the positions Pxyz, are obtained. In the example described here, the vectorial data are obtained for the roads.

In the embodiment described here, the generating method according to the invention comprises a step of correcting the morphology of an obstacle based on the height of this obstacle, without taking the vectorial data into account.

For example, an obstacle of “Grass” morphology of more than 5 metres can be reclassified as “Forest” morphology.

The corrections can also take account of the morphology of the obstacles surrounding the obstacle in question.

More precisely, the method according to the invention can comprise a correction step consisting of assigning, to an obstacle the morphology of which is incompatible with its height, a dominant morphology compatible with its height among the obstacles surrounding this obstacle.

For example, the obstacles of “free” morphology of height [10 m-15 m] can be reclassified with the predominant morphology of the surrounding obstacles of the same height class [10 m-15 m] among the urban environment, city centre, commercial centre and forest morphologies. An error is thus corrected, as the morphology of the “free” type is supposed to represent an area free from any structure or vegetation, which is incompatible with a height of 10 to 15 metres, This principle of substitution of a morphology makes it possible to correct errors in the morphology initially derived from statistical sources the reliability of which is not as good as that of the elevation data,

Example of Correction Taking into Account the Vectorial Data:

In the embodiment described here, the morphology of an obstacle can be reclassified based on the height class of this obstacle and vectorial data of this obstacle, without taking into account the morphology of the surrounding obstacles: for example, vectorial information identifying an area as being a motorway (Road morphology) will be used in conjunction with the height of the obstacle for modelling an elevated road. Thus, a class “Road 5-10 m” will be obtained for a motorway elevated by 5 to 10 m. This approach allows very accurate modelling of bridges and elevated motorways.

In the embodiment described here, the height class of an obstacle is not modified on the basis of its morphology.

FIG. 4 shows an example of a computer 10 according to the invention. This computer comprises a processor 11, a high-speed memory of the RAM type 12 and a read-only memory of the ROM type 13 comprising a computer program PG capable of implementing the method shown in the form of a flowchart in FIG. 2. It also comprises a database for storing the data Mxy, DSMxyz, DTMxyz, Hxy and C described above.

The processor 11, the memories 12 and 13 and the program PG constitute in particular:
means for obtaining a satellite image supplying the morphologies Mxy of obstacles Oxy at certain geographic positions Pxy in a geographic area;
means for obtaining first data DSMxyz, second data DTMxyz;
means for calculating the height Hxy of obstacles Oxy; and
means for generating a cartography capable of associating the morphology Mxy of the obstacle with the height Hxy of the obstacle, at geographic positions.

In the embodiment described here, the cartography obtained by the generating method of FIG. 2 is used for simulating the propagation of an electromagnetic wave in the geographic area.

As has already been described in detail above, this cartography associates a morphology with a height or height class, for each obstacle in the area.

In order to carry out the propagation simulation, it is of course also necessary to know the height of the obstacles relative to the ground. For this, the user uses data DTM on altitude of the ground relative to sea level at different geographic points in said area, the latter being obtainable by radar.

The cartography can also be used for modelling the traffic in a telecommunications network installed in the geographic area.

1. A method for generating a cartography of a geographic area, the method comprising:
a step of obtaining a multispectral satellite image supplying morphologies of obstacles at certain geographic positions in said area;
a step of obtaining first data on altitude of the tops of said obstacles relative to sea level;
a step of obtaining second data on altitude of the ground at said geographic positions relative to sea level;
a step of calculating the height of said obstacles by the difference between said first and second data; and
a step of generating said cartography by associating, at each of said geographic positions, said morphology of the obstacle with the height of the obstacle.

2. The method for generating a cartography according to claim 1, characterized in that it comprises a step of correcting said morphology of an obstacle based on the height of said obstacle.

3. The method for generating a cartography according to claim 1, characterized in that it comprises:
a step of obtaining third vectorial data representative of the geographic position of certain of said obstacles; and
a step of correcting said cartography by correcting at least said morphologies and/or said first data and/or said second data based on said third data at said position.

4. The method for generating a cartography according to claim 3, characterized in that said correction consists of assigning, to an obstacle the morphology of which is incompatible with its height,
a dominant morphology
compatible with said height among the obstacles surrounding said obstacle.

5. A method for simulating the propagation of an electromagnetic wave in a geographic area comprising:
a step of generating a cartography of said geographic area according to claim 1; and
a step of simulating the propagation of the wave using said cartography and data on altitude of the ground relative to sea level at different geographic points in said area.

6. The use of a cartography of a geographic area according to claim 1 for modelling the traffic in a telecommunications network.

7. A computer able to generate a cartography of a geographic area, said computer comprising:
means for obtaining a multispectral satellite image supplying morphologies of obstacles at certain geographic positions of said area;
means for obtaining first data on altitude of the tops of said obstacles relative to sea level;
means for obtaining second data on altitude of the ground at said geographic positions relative to sea level;
means for calculating the height of said obstacles by the difference between said first and second data; and
means for generating said cartography by associating, at each of said geographic positions, said morphology of the obstacle with the height of the obstacle.

8. A computer program comprising instructions for execution of the steps of the method for generating a cartography of a geographic area according to claim 1 and/or instructions for
execution of the steps of a method of simulation when said program is executed by a computer including the following: means for obtaining a multispectral satellite image supplying morphologies of obstacles at certain geographic positions of said area;
means for obtaining first data on altitude of the tops of said obstacles relative to sea level;
means for obtaining second data on altitude of the ground at said geographic positions relative to sea level;
means for calculating the height of said obstacles by the difference between said first and second data; and
means for generating said cartography by associating, at each of said geographic positions, said morphology of the obstacle with the height of the obstacle.

9. A computer-readable recording medium on which a computer program is recorded comprising instructions for execution of the steps of the method for generating a cartography of a geographic area according to claim 1 and/or instructions for execution of the steps of a method of simulation including a step of generating a cartography of said geographic area according to claim 1; and
a step of simulating the propagation of the wave using said cartography and data on altitude of the ground relative to sea level at different geographic points in said area.
